(19) United States
(12) Patent Application Publication
(10) Pub. No.: US 2013/0228513 A1
(43) Pub. Date: Sep. 5, 2013

(54) GRADIENT SEPARATION METHOD TRANSFER FOR LIQUID CHROMATOGRAPHY SYSTEMS

(71) Applicant: WATERS TECHNOLOGIES CORPORATION, Milford, MA (US)

(72) Inventor: Richard W. Andrews, Rehoboth, MA (US)

(73) Assignee: WATERS TECHNOLOGIES CORPORATION, Milford, MA (US)

(21) Appl. No.: 13/748,865

(22) Filed: Jan. 24, 2013

Related U.S. Application Data
(60) Provisional application No. 61/605,812, filed on Mar. 2, 2012.

(51) Int. Cl. B01D 15/10

(52) U.S. Cl. CPC B01D 15/10
USPC 210/635; 210/141

(57) ABSTRACT

Described is a method of transferring a gradient separation method to a liquid chromatography system. A value of a delivered gradient slope for a gradient separation method performed on a first liquid chromatography system is determined based on a value of a programmed gradient slope for the gradient separation method and a predetermined relationship between delivered gradient slope and programmed gradient slope for the first liquid chromatography system. The gradient separation method is performed on a second liquid chromatography system using a delivered gradient slope having a value equal to the value of the delivered gradient slope determined for the first liquid chromatography system

### RELATED APPLICATION

This application claims the benefit of the earlier tiling date of U.S. Provisional Patent Application Ser. No. 61/605,812, filed Mar. 2, 2012 and titled “Gradient Separation Method Transfer for Liquid Chromatography Systems,” the entirety of which is incorporated herein by reference.

### FIELD OF THE INVENTION

The invention relates generally to a method to transfer a gradient separation from one liquid chromatography system to a different liquid chromatography system. More particularly, the invention relates to the determination of a gradient slope for obtaining similar elution for common samples independent of a particular type of liquid chromatography system.

### BACKGROUND

Gradient solvent delivery systems have been developed that are optimized for ultra-high pressure liquid chromatography (UHPLC) systems utilizing small analytical columns. UHPLC delivery systems can deliver solvents at significantly greater pressure than pumps used in delivery systems configured for high-performance liquid chromatography (HPLC). A gradient solvent delivery system for UHPLC typically has a smaller dwell volume and a smaller volume for mixing mobile phase solvents than an HPLC gradient solvent delivery system. Advantageously, UHPLC systems typically yield sharper peaks in chromatograms while using less solvent, having lower carryover and enabling faster system re-equilibration for gradient methods.

A significant number of existing analytical methods that have been validated or incorporated into compendia such as the United States Pharmacopeia (USP) or the European Pharmacopeia (EP) were developed using gradient solvent delivery systems optimized for HPLC. Difficulties can arise when attempting to transfer a method developed for an HPLC system to a UHPLC system. The cost of validation of the method on the UHPLC system may be prohibitive. In addition, the difference in the dwell volumes and mixing volumes can lead to differences in resolution and retention times.

### SUMMARY

in one aspect, the invention features a method of transferring a gradient separation method to a liquid chromatography system. The method includes determining a value of a delivered gradient slope for a gradient separation method performed on a first liquid chromatography system. The determination is based on a value of a programmed gradient slope for the gradient separation method and a predetermined relationship between delivered gradient slope and programmed gradient slope for the first liquid chromatography system. The method also includes performing the gradient separation method on a second liquid chromatography system using a delivered gradient slope having a value equal to the value of the delivered gradient slope determined for the first liquid chromatography system.

In another aspect, the invention features an apparatus for determining a programmed gradient slope for a transferred gradient separation method for a liquid chromatography system. The apparatus includes a user input device, a memory module and a processor in communication with the user input device and the memory module. The user input device is configured to receive data indicative of a gradient separation method to be transferred from a first liquid chromatography system to a second liquid chromatography system. The data includes a type of the first liquid chromatography system and a programmed slope for the gradient separation method. The memory module is configured to store data representative of a functional correspondence of delivered gradient slope to programmed gradient slope for a plurality of types of liquid chromatography systems including the type of the first liquid chromatography system. The processor is configured to receive the data indicative of the gradient separation method to be transferred and to determine, in response thereto, a delivered gradient slope for the second liquid chromatography system.

In still another aspect, the invention features a computer program product for transferring a gradient separation method to a liquid chromatography system. The computer program product includes a computer readable storage medium having computer readable program code. The computer readable program code includes computer readable program code configured to determine a value of a delivered gradient slope for a gradient separation method performed on a first liquid chromatography system. The determination is based on a value of a programmed gradient slope for the gradient separation method and a predetermined relationship between delivered gradient slope and programmed gradient slope for the first liquid chromatography system. The computer readable program code also includes computer readable program code configured to perform the gradient separation method on a second liquid chromatography system using a delivered gradient slope having a value equal to the value of the delivered gradient slope determined for the first liquid chromatography system.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is a graphical representation of the performance of typical HPLC and UHPLC gradient solvent delivery systems expressed as a relative contribution of one of the solvents of the mobile phase as a function of time.

FIG. 2 is a graphical presentation of measurement data for a binary solvent where each curve indicates the measured relative composition for one of the solvents as a function of time for a specific programmed gradient.

FIG. 3 is a graphical presentation of the measured delivered slopes of an Alliance® 2695 HPLC system according to FIG. 2 as a function of programmed slopes.

FIG. 4 shows chromatograms for a method performed with an Acquity® QSM H-Class LC system and an Alliance 2695 HPLC system at a programmed gradient slope of 42.5%/min. at 1.4 ml/min.

FIG. 5 shows a chromatogram for a gradient programmed slope of 82.5% for the Acquity QSM H-Class LC system and a chromatogram for a gradient programmed slope of 85%/min. for the Alliance 2695 HPLC system.

FIG. 6 shows a chromatogram for a gradient programmed slope of 150%/min. for the Alliance 2695 HPLC system and a chromatogram for a gradient programmed slope of 135.5%/min for the Acquity QSM H-Class LC system.

FIG. 7 shows chromatograms for the Alliance 2695 HIP system and the Acquity QSM H-Class LC system for a ballistic gradient command.

FIG. 8 is a graphical presentation of a quadratic equation fit the data points tier measured delivered slope as a function of programmed slope for a LC system.

FIG. 9 is a graphical presentation of the data for measured gradient fidelity curves for 1.0 mL/min. and 1.4 mL/min. flow rates for the Alliance 2695 HPLC system.

FIG. 10 shows a chromatogram for a gradient separation method performed on the Alliance 2695 HPLC system with a 1.4 mL flow rate and a chromatogram resulting from transfer of the gradient separation method to the Acquity QSM H-Class LC system with a flow rate of 1.0 mL/min.

FIG. 11 is a flowchart representation of an embodiment of a method of transferring a gradient separation method from a first LC system to a second LC system according to the invention.

FIG. 12 is a block diagram of a computing system in which an embodiment of the method of FIG. 11 can be practiced.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system,” Furthermore, aspects of the present invention may take the form of a computer program product embodied in one or more computer readable mediums having computer readable program code embodied thereon.

Any combination of one or more computer readable mediums may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific but non-exhaustive examples of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. More generally, as used herein a computer readable storage medium may be any tangible medium that can contain, or store a program for use by or in connection with an instruction execution system, apparatus or device.

Computer program code for carrying out operations for aspects of the present invention may be written in any combination of one or more programming languages. The program code may execute entirely on the user's computing system, partly on the user's computing system, as a stand-alone software package, partly on the user's computing system and partly on a remote computing system or entirely on the remote computing system or server. In the latter scenario, the remote computing system may be connected to the user's computing system through any type of network, including a local area network (LAN) or a wide area network (WAN), or the connection may be made to an external computer (for example, through the Internet using an Internet Service Provider).

The differences between HPLC and UHPLC gradient solvent delivery systems include differences in dwell volumes and differences in mixing volumes. The performance characteristics of a gradient delivery system can be compared to the performance characteristics of an electronic filter. In particular, the dwell volume, or volume delay, is similar to the phase shift imparted to an electrical signal by an electronic filter. The volume delay corresponds to the volume of the mobile phase that must pass before a programmed change in the mobile phase becomes effective. In addition, the response to a programmed step change in the relative composition of solvents in the mobile phase is analogous to the rise time or impulse response of an electronics filter.

At low programmed gradient slopes (e.g., less than a 25%/min. composition change rate), the delivered (i.e., “actual”) gradient slope for many HPLC systems is substantially equal to the programmed slope. At greater values of the programmed gradient slope, the gradient slope is attenuated and the delivered gradient slope can be significantly less than the programmed value. For many HPLC systems, the maximum delivered gradient slope is approximately 200%/min. for a programmed step change (i.e., instantaneous change). In contrast, delivery systems for UHPLC are typically capable of providing a substantially greater maximum delivered gradient slope and can provide a more accurate delivered gradient slope over a greater range of values of programmed gradient slope. Consequently, when an HPLC method is transferred to a UHPLC system, the delivered gradient slope can be significantly greater than the delivered gradient slope for the HPLC method performed with an HPLC system. Because the resolution in gradient chromatograms is inversely proportional to the gradient slope, a lower gradient slope can result in a greater chromatographic resolution. Thus the improved gradient fidelity of the UHPLC system can result in a distortion of the UHPLC gradient separation chromatogram relative to the original HPLC gradient separation chromatogram.

In brief overview, the present invention relates to a method of transferring a gradient method to a liquid chromatography system. The method is particularly beneficial for instances of method transfer between an HPLC system and UHPLC system, and to HPLC systems in which the dwell and mixing volumes are different. A value of a delivered (i.e., actual) gradient slope is determined for a gradient separation method performed on a liquid chromatography system. The determination is based on a value of a programmed gradient slope for the gradient separation method and a predetermined relationship between delivered gradient slope and programmed gradient slope for the liquid chromatography system. The gradient separation method is performed on a different liquid chromatography system using a delivered gradient slope having a value equal to the value of the delivered gradient slope determined for the first liquid chromatography system.

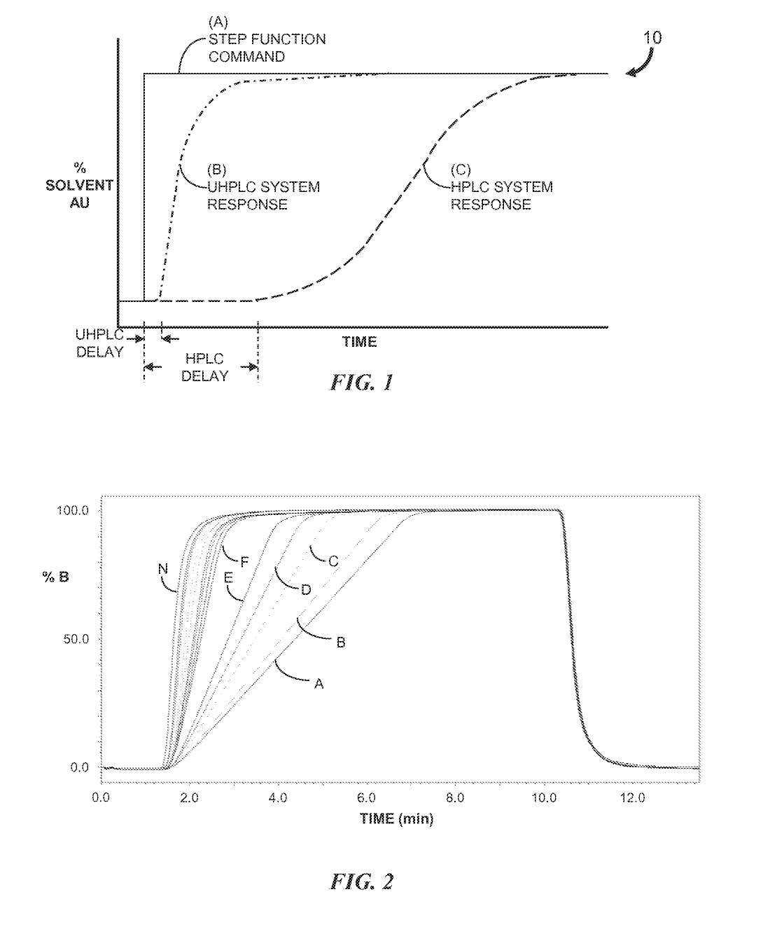

FIG. 1 provides a graphical example of the performance of typical HPLC and UHPLC gradient solvent delivery systems expressed as a relative contribution of one of the solvents of the mobile phase as a function of time. Alternatively, the horizontal axis can be expressed in terms of volume for a constant flow rate. In the illustrated example, a step function increase (A) in the relative (i.e., percentage) composition of a solvent in the mobile phase is commanded. As used herein, a command means an instruction, signal or the like that is provided to a solvent delivery system to control the value of the relative composition. For example, the command may be issued in response to one or more composition values or gradient slope values programmed by an operator of the LC system. The mixing characteristics of the two delivery systems generally differ. Although the mixers in both delivery systems have an attenuated response, the UHPLC delivery system typically has a smaller rise volume or, equivalently, rise time. Thus the UHPLC response (B) has a greater delivered slope than the HPLC response (C) and therefore enables a more rapid change in the relative composition.

Column calculators, also known as method transfer calculators or method transfer tools, are software-based tools that are often used in the transfer of a gradient separation method from one LC system to a different LC system. Herein reference is made to a first LC system and a second LC system to indicate the LC system previously used with the gradient separation method and the LC system to which the gradient separation is being transferred, respectively. It should be understood that the first LC system typically was previously used to obtain chromatographic data according to the particular gradient separation method prior to performing the transferred method on the second LC system. According to common techniques for methods transfer, values relevant to the first LC system, such as the dwell volume and column volume for the first LC system, are entered into the calculator. If the dwell volume varies with increasing system backpressure, for example, as a consequence of pneumatic pulse dampening, an adjustment to the value of the dwell volume according to the predicted backpressure is generally required. Most calculators correct for differences in the dwell volumes and column volumes of the first and second LC systems by applying appropriate scaling factors or other techniques. For example, the flow rate can be scaled to account for a change in the column dimensions and column particle size. In addition, dwell volume differences can be addressed by implementing an isocratic hold or by recommending a pre-injection volume or post-injection volume. In some instances, the column temperature is controlled in a manner to obtain similar retention characteristics between the two LC systems as described, for example, in PCT Publication No. WO 2011/091224, titled “Method for Determining Equivalent Thermal Conditions between Liquid Chromatography Systems,” incorporated herein by reference.

Conventional column calculators do not address the differences in the mixing characteristics of the two LC systems. In particular, the rise volume is not a required input and the gradient slopes that are actually delivered by the LC systems are not modeled. If a method is transferred from a HPLC system to a UHPLC system without accounting for the difference in the slopes of the responses, the peaks in the UHPLC chromatogram will be shifted relative to the peaks in the HPLC chromatogram. In addition, the peaks in the HPLC chromatogram may have better resolution, that is, greater differences in the retention times between equivalent pairs of peaks.

FIG. 2 shows measurement data for a binary solvent (solvents A and B). Each curve indicates the measured relative composition for solvent B as a function of time for a specific programmed gradient. The gradients were executed using an Alliance® 2695 HPLC system manufactured by Waters Corporation of Milford, Mass. at a 1.4 mL/min. flow rate. The gradients were programmed for changes of 0% to 100% composition of solvent B for the following programmed gradient slopes: 18.7, 21.25, 28.3, 34, 42.5, 85, 95, 105, 115, 150, 200, 300 and 400%/min., and an instantaneous (step function) command. The plotted gradient data (Gradients A to N) correspond to the programmed gradient slopes as follows: Gradient A is 18.7%/min., Gradient B is 21.25%/min., Gradient C is 28.3%/min. and so forth to Gradient N which is the programmed instantaneous command. A limiting gradient slope of approximately 200%/min. is evident in the measurement data for the instantaneous command (Gradient N).

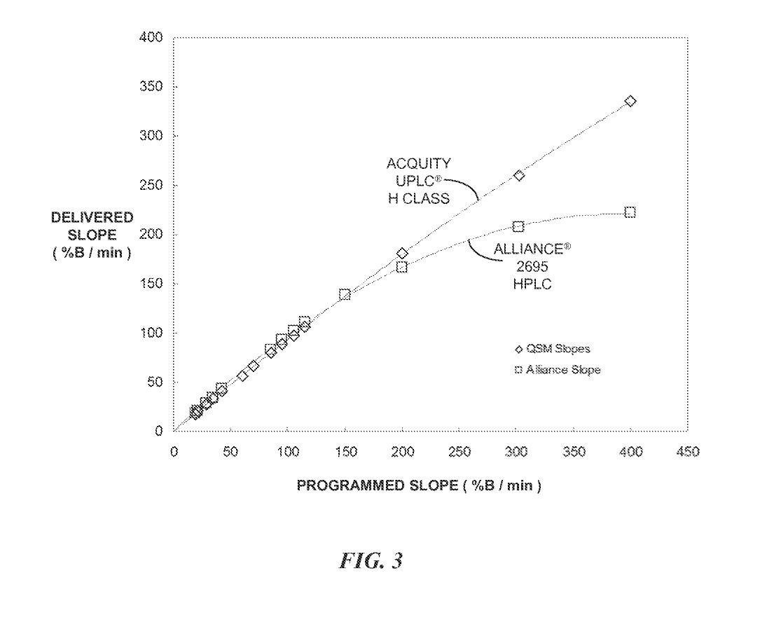

FIG. 3 shows the delivered slopes (i.e., measured slopes) of the Alliance 2695 HPLC system from FIG. 2 as a function of programmed slopes. At lower programmed slopes, the delivered gradients accurately follow the commanded gradient slope; however, at higher programmed slopes, the delivered slope is less than the programmed slope and the difference between the delivered and programmed slopes increases in a rapidly nonlinear manner. Also shown is the functional relationship between delivered slope and programmed slope for an Acquity® QSM H-Class system manufactured by Waters Corporation of Milford, Mass. Although shown only to a programmed slope of 400 percent/min., the Acquity QSM delivered slope accurately tracks the Acquity QSM programmed slope to approximately 700%/min.

A chromatographic method can be transferred from one LC system to a different LC system without limitation on how accurately the delivered slope matches the programmed slope as long as the delivered slopes for each of the two LC systems are acceptable and are approximately equal for the same programmed slope. Thus a method can be transferred from the Alliance 2695 HPLC system to the Acquity QSM H-Class system over a range of programmed slopes that are less than or equal to a “break point” programmed slope because the delivered slopes are nearly equal. Both LC systems deliver the requested slopes with good fidelity up to about 85%B/min; however, above this value the delivered slopes for the Alliance 2695 HPLC system departs sufficiently from the programmed slope values and the delivered slopes for the Acquity QSM H-Class system such that chromatograms for the two LC systems differ significantly. This difference is due to the sensitivity of the retention times to small changes in the delivered slope.

Retention times in gradient chromatography depend upon a number of compound specific parameters which include the retention factor at zero percent strong solvent and a compound specific slope sensitivity factor which can be estimated from a plot of the natural logarithm of retention factor according to percent composition. Consequently, for heterogeneous samples the degree of sensitivity to changes in gradient slope varies greatly.

The lesser delivered slope of the Alliance 2695 HPLC system results in a higher apparent resolution in the gradient chromatogram. To ensure proper transfer of the method to the Acquity QSM H-Class system, the programmed slope of the Acquity QSM. H-Class system is decreased to a value that results in a delivered slope that is equivalent to the delivered slope for the Alliance 2695 HPLC system at the higher programmed slope for the method. This modification in the programmed slope yields more closely matched chromatograms although the Acquity QSM H-Class system generally yields narrower peaks at common retention tunes. In effect, the transferred method is “optimized” to correspond to the retention times and resolution of the peaks of the original chromatogram.

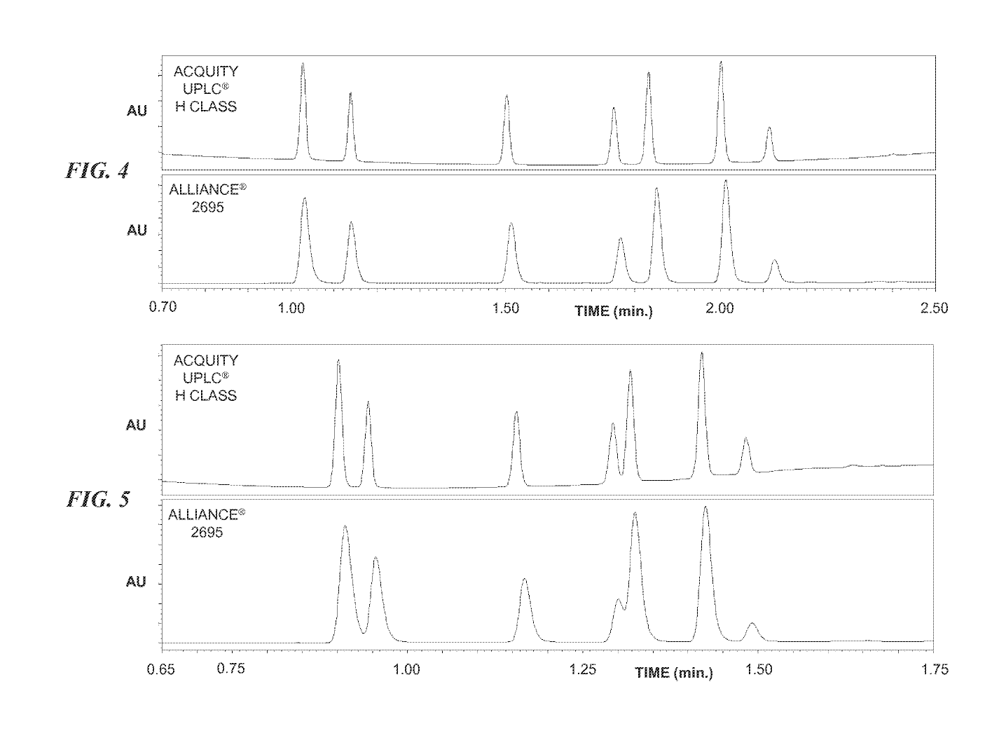

FIG. 4 shows chromatograms for a method performed with the Acquity QSM H-Class LC system and the Alliance 2695 HPLC system. The programmed gradient slope is 42.5%/min. at 1.4 mL/min. The sample includes solutes with a wide range of polarity and hydrophobicities. In order of elution, the separated compounds include 2-acetylfuran, acetanilide, acetophenone, propiophenone, butylparaben, benzophenone and valerophenone. The retention times and the peak spacings are nearly equal. The dwell volume was adjusted for the method transfer; however, the programmed gradient slope for the Acquity QSM system is maintained as identical to the programmed gradient slope for the Alliance 2695 system because the corresponding delivered slopes are substantially equal.

FIG. 5 shows a chromatogram for a gradient programmed slope of 85%/min. for the Alliance system and for a gradient programmed slope of 82.5% for the Acquity system. To Obtain similar resolution and retention times, the Acquity system used the smaller programmed slope of 82.5%/min. to closely match the delivered slope of approximately 82.5% for the Alliance system. Due to extra system dispersion, the peaks in the Alliance chromatogram are wider than the corresponding peaks in the Acquity chromatogram.

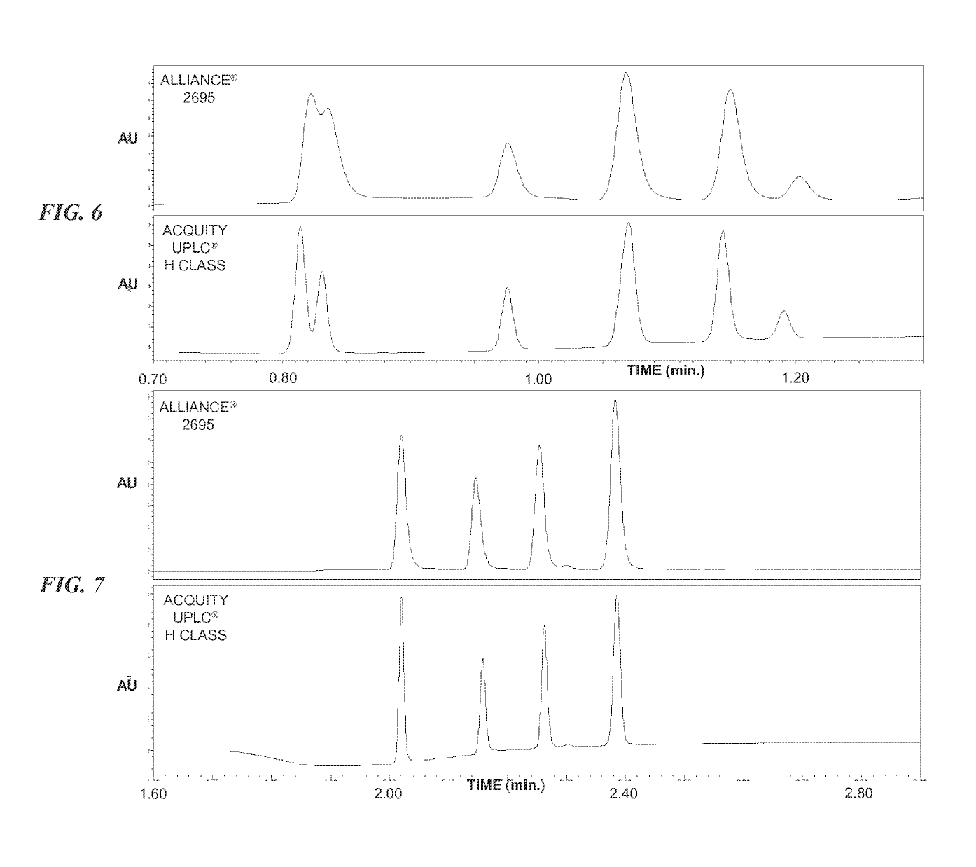

FIG. 6 shows a chromatogram for a gradient programmed slope of 50%/min. for the Alliance system. Also shown in the figure is a chromatogram achieved with the Acquity system using a programmed slope of 135.5%/min. Although the programmed slope of the Acquity system is 14.5%/min. less than the programmed slope of the Alliance system, both systems have the same delivered slope and therefore the retention times are substantially equal. Again, the wider peak widths in the Alliance LC chromatogram are due to greater system dispersion in comparison to the Acquity LC system.

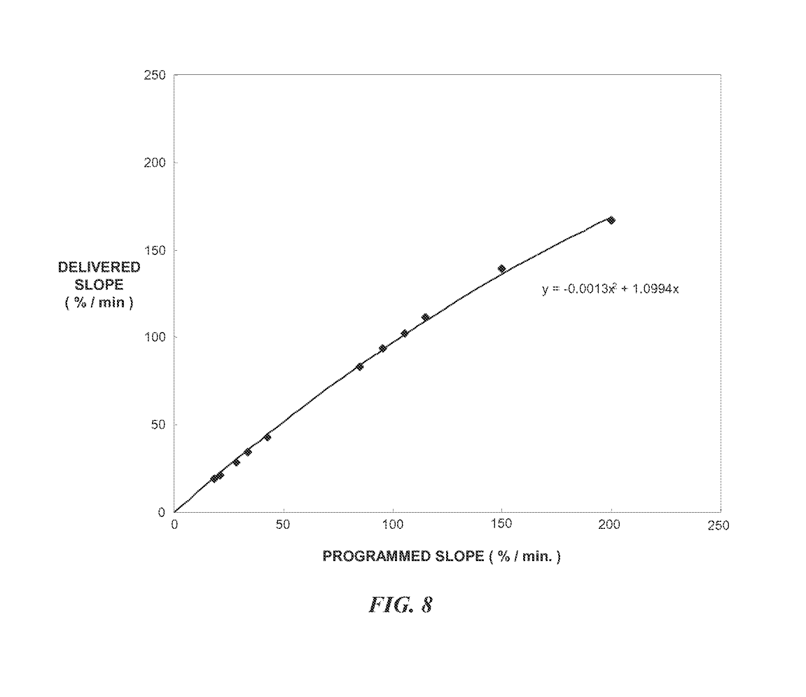

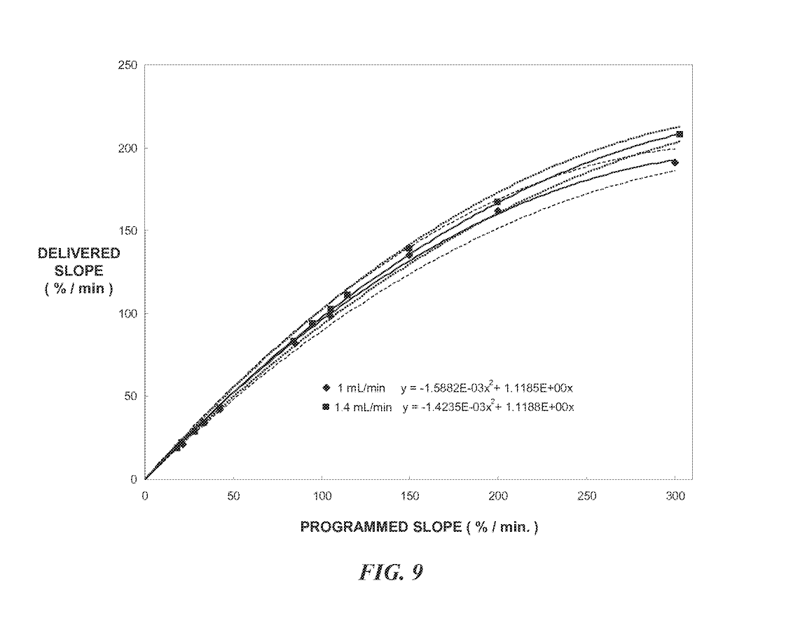

FIG. 7 shows chromatograms for the two LC systems that result from a ballistic gradient command. In this instance, the command is for an instantaneous change from a mobile phase of approximately 0% acetonitrile to 100% acetonitrile. The separation was performed for four alkylphenones. In order of elution, the compounds included butyrophenone, valerophenone, hexanophenone and decanophenone. As previously described, a limited gradient slope of approximately 200%/min. is delivered for a step function programmed slope on the Alliance system. Using a programmed slope of 200%/min. for the Acquity system results in a delivered slope of approximately 200%/min. and therefore the retention times of the chromatogram for the Acquity system closely matches the retention times of the Alliance chromatogram. Although the Acquity system is capable of a substantially greater delivered slope (i.e., at least 700%/min.), the system is programmed to the substantially lower slope to match the maximum deliverable slope of the Alliance system and therefore to yield a similar chromatographic result.

In one aspect, the invention relates to a module that includes data that represent the delivered slope as a function of programmed slope for a plurality of LC systems. In preferred embodiments, the relationship for the delivered slope as a function of programmed slope (i.e., the “gradient fidelity curve”) for each LC system is predetermined by performing a sequence of measurements on the LC system. For example, the delivered slope is measured for a plurality of programmed slopes. A quadratic equation is mathematically fit to the measurement data points for the gradient fidelity curve. The coefficients of the quadratic equation can later be used to determine the delivered slope for any given programmed slope of the corresponding LC system within the range of measurement data. In general, the quadratic equation is useful for predicting the delivered slope within a ±2%/min. window. FIG. 8 shows an example of a quadratic equation fit the data points for a LC system. The value of x is the programmed slope and the value of y is the corresponding delivered slope for the LC system.

FIG. 9 shows the measured gradient fidelity curves for 1.0 mL/min. and 1.4 mL/min. flow rates for the Alliance 2695 HPLC system. The pair of dashed lines surrounding each curve indicate the ±95% confidence intervals of the quadratic fit to the slope data. The pump changes stroke length in response to the flow rate to preserve compositional accuracy. The separation of the gradient fidelity curves becomes increasingly apparent for higher values of programmed slope. Thus a set of measurement data can be acquired for gradient slope fidelity curves for a number of flow rates. The data for each flow rate are fit to a quadratic equation. To transfer a method from the LC system, the delivered slope is determined using the quadratic curve associated with the flow rate for the method.

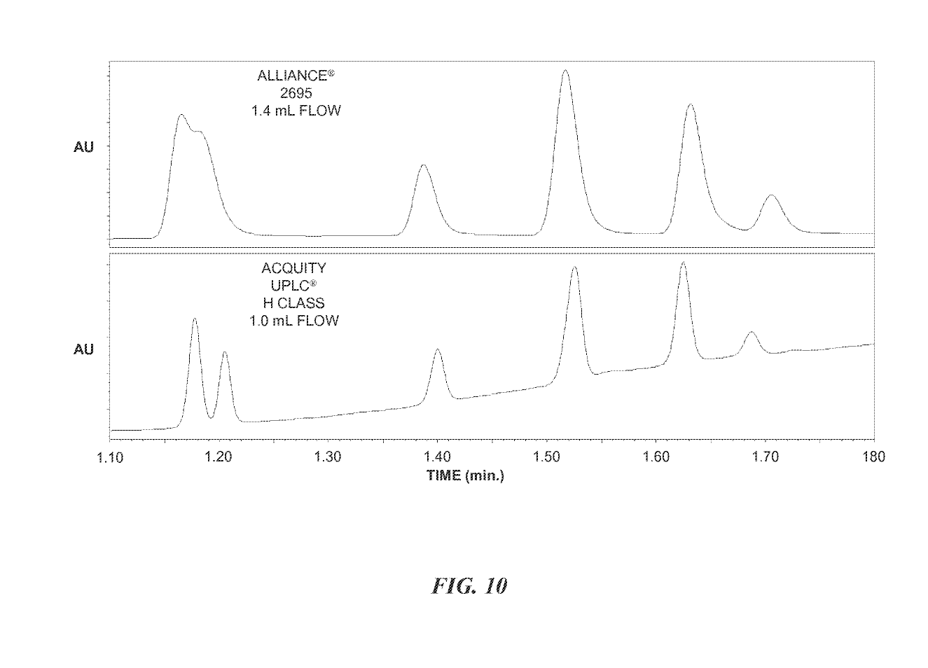

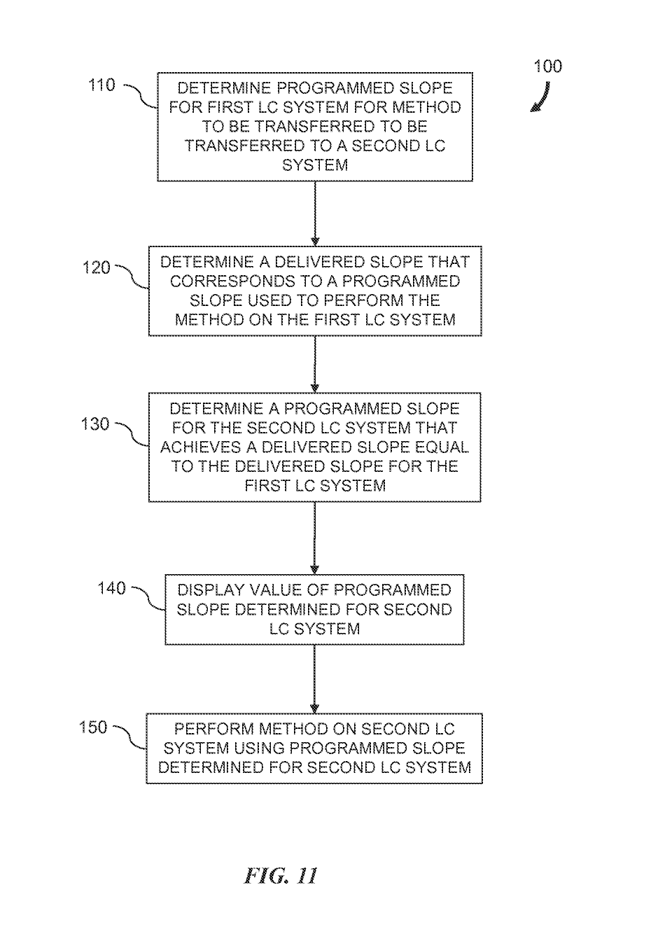

In many instances, especially at lower programmed slope values, the difference between the gradient fidelity curves can be ignored. For example, FIG. 10 shows a. chromatogram for a gradient separation performed on the Alliance 2695 HPLC system with a 1.4 mL flow rate. The programmed slope was 105% B/min., corresponding to a delivered slope of 100% B/min. Also shown in FIG. 10 is a chromatogram resulting from transfer of the method to the Acquity QSM H-Class LC system with a flow rate of 1.0 mL/min. In this example, no accommodation of the difference in flow rates was applied. The chromatograms exhibit high correlation of peak retention times although the Acquity LC system has better resolution due to lower system dispersion.

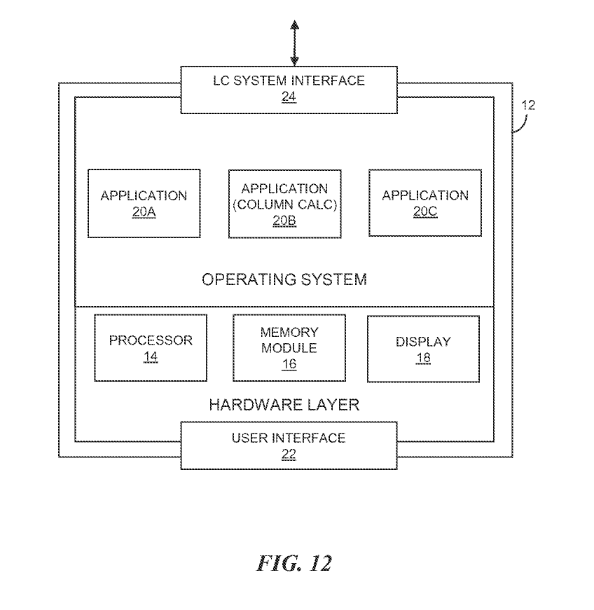

FIG. 11 is a flowchart representation of an embodiment of a method 100 of transferring a gradient separation method from a first LC system to a second LC system. The method 100 is based in part on matching the delivered slopes of the two LC systems. FIG. 12 illustrates a computing system 12 in which an embodiment of the method 100 can be practiced. The computing system or apparatus 12 has hardware components that include a processor 14, a memory module 16 for persistent storage of data and software programs, and a display 18. The computing system 12 also includes an operating system that enables execution of a number of applications 20A to 20C (only three depicted for clarity) by the processor 14. The computing system 12 further includes a user interface 22 having at least one input device (e.g., a keyboard, mouse, trackball, touch-pad and/or touch-screen). Exemplary embodiments of the computing system 12 include, but are not limited to, a personal computer (PC), a Macintosh computer, a workstation, a laptop computer and a mainframe computer. As shown, the computing system 12 can communicate via an interface 24 with a LC system for performing a gradient separation method although this is not a requirement.

Referring to FIG. 11 and FIG. 12, an operator interacts by way of the user interface 22 with a column calculator application 20B. To transfer the method, an operator determines (step 110) the programmed slope used to perform the method on the prior (first) LC system. The operator enters the value of the programmed slope at the user interface 22. The processor 14 then determines (step 120) the delivered slope for the first LC system that corresponds to the programmed slope. In a preferred embodiment, the determination is made using a predetermined quadratic equation describing the delivered slope as a function of the programmed slope. The quadratic equation can be stored, for example, as coefficients in the memory module 16. In an alternative embodiment, the delivered slope is determined (step 120) from a table of values stored in the memory module 16 that characterize the delivered slope as a function of programmed slope.

In some instances, the determination (step 120) of the delivered slope can be based first on a comparison of the programmed slope to a predetermined constant. The constant represents a maximum slope value for which the difference between the delivered slope and the programmed slope is sufficiently small so that no adjustment to the programmed slope is necessary on the second LC system. Thus if the programmed slope does not exceed the predetermined constant, the delivered slope is determined to be the same as the programmed slope.

The processor 14 determines (step 130) a programmed slope for the second LC system that will perform the transferred method using a delivered slope that is the same as the delivered slope for the first LC system. The determined value is displayed (step 140) to the operator. The programmed slope for the second LC system may be substantially the same as the delivered slope, for example, for method transfer to some UHPLC systems. In contrast, the programmed slope for the second LC system can be substantially different than the delivered slope, for example, for method transfer to various HPLC systems, especially at higher values of programmed slope. The method is performed (step 150) on the second LC system using the programmed slope determined for the second LC system.

In the illustrated embodiment the computing system 12 includes an interface 24 to an LC system. Thus the value of the determined programmed slope can be provided directly to a control system for the second LC system. In other embodiments the computing system can be independent of the second LC system. For example, the computing system can be physically remote to the second LC system. In one embodiment, the computing system may be, at least in part, separate from an operator user interface. By way of example, the computing system can be a server accessible over a network such as for a web-based implementation wherein data are transmitted via the Internet.

While the invention has been shown and described with reference to specific embodiments, it should be understood by those skilled in the art that various changes in form and detail may be made therein without departing from the spirit and scope of the invention as recited in the accompanying claims.

What is claimed is:

1. A method of transferring a gradient separation method to a liquid chromatography system, the method comprising:
determining a value of a delivered gradient slope for a gradient separation method performed on a first liquid chromatography system, the determination being based on a value of a programmed gradient slope for the gradient separation method and a predetermined relationship between delivered gradient slope and programmed gradient slope for the first liquid chromatography system; and
performing the gradient separation method on a second liquid chromatography system using a delivered gradient slope having a value equal to the value of the delivered gradient slope determined for the first liquid chromatography system.

2. The method of claim 1 wherein the programmed gradient slope and the delivered gradient slope for the first liquid chromatography system are different.

3. The method of claim 1 wherein performing the gradient separation method on the second liquid chromatography system comprises programming a gradient slope for the second liquid chromatography system that is predetermined to achieve the delivered gradient slope for the second liquid chromatography system.

4. The method of claim 1 further comprising determining the relationship between delivered gradient slope and programmed gradient slope for the first liquid chromatography system.

5. The method of claim 1 wherein one of the first and second liquid chromatography systems is a high-performance liquid chromatography system and wherein the other of the first and second liquid chromatography systems is an ultra-performance liquid chromatography system.

6. The method of claim 1 wherein first liquid chromatography system and the second liquid chromatography system are high-performance liquid chromatography systems.

7. The method of claim 1 wherein determining a value of a delivered gradient slope comprises determining the value from a plurality of values of predetermined delivered gradient slopes, each of the values of the predetermined delivered gradient slopes corresponding to a value of a programmed gradient slope fix the first liquid chromatography system.

8. The method of claim 7 wherein the plurality of values are predetermined for a flow rate that is substantially equal to a flow rate for the second liquid chromatography system.

9. The method of claim 4 wherein the predetermined relationship between delivered gradient slope and programmed gradient slope for the first liquid chromatography system is determined by performing a fit of a mathematical function to a plurality of data points, each of the data points indicating a value of a programmed gradient slope and a delivered gradient slope predetermined to correspond to the value of the programmed gradient slope.

10. The method of claim 9 wherein the predetermined relationship between delivered gradient slope and programmed gradient slope is determined at a flow rate that is substantially equal to a flow rate for the second liquid chromatography system.

11. An apparatus for determining a programmed gradient slope for a transferred gradient separation method for a liquid chromatography system, comprising:
a user input device to receive data indicative of a gradient separation method to be transferred from a first liquid chromatography system to a second liquid chromatography system, the data comprising a type of the first liquid chromatography system and a programmed slope for the gradient separation method;
a memory module configured to store data representative of a functional correspondence of delivered gradient slope to programmed gradient slope for a plurality of types of liquid chromatography systems including the type of the first liquid chromatography system; and
a processor in communication with the user input device and the memory module, the processor receiving the data indicative of the gradient separation method to be transferred and determining in response thereto a delivered gradient slope for the second liquid chromatography system.

12. The apparatus of claim 11 wherein the memory module is configured to store a lookup table comprising a plurality of data for the functional correspondence of delivered gradient slope to programmed gradient slope for the plurality of types of liquid chromatography systems.

13. The apparatus of claim 11 wherein the processor calculates the delivered gradient slope for the liquid chromatography system based on the data indicative of the gradient separation method to be transferred and stored data representative of the functional correspondence of delivered gradient slope to programmed gradient slope for the second liquid chromatography system.

14. The apparatus of claim 13 wherein the stored data representative of the functional correspondence comprises data defining a fit of a mathematical function to a plurality of data points, each of the data points indicating a delivered gradient slope predetermined to occur in response to a programmed gradient slope for the second liquid chromatography system.

15. A computer program product for transferring a gradient separation method to a liquid chromatography system, the computer program product comprising:
a computer readable storage medium having computer readable program code embodied therewith, the computer readable program code comprising:
computer readable program code configured to determine a value of a delivered gradient slope for a gradient separation method performed on a first liquid chromatography system, the determination being based on a value of a programmed gradient slope for the gradient separation method and a predetermined relationship between delivered gradient slope and programmed gradient slope for the first liquid chromatography system; and
computer readable program code configured to perform the gradient separation method on a second liquid chromatography system using a delivered gradient slope having a value equal to the value of the delivered gradient slope determined for the first liquid chromatography system.

16. The computer program product of claim 15 wherein the computer readable program code configured to perform the gradient separation method on the second liquid chromatography system comprises computer readable program code configured to program a gradient slope for the second liquid chromatography system that is predetermined to achieve the delivered gradient slope for the second liquid chromatography system.

17. The computer program product of claim 15 wherein the determination of the value of the delivered gradient slope comprises determining the value from a plurality of values of predetermined delivered gradient slopes, each of the values of the predetermined delivered gradient slopes corresponding to a value of a programmed gradient slope for the first LC system.

18. The computer program product of claim 15 wherein the predetermined relationship between delivered gradient slope and programmed gradient slope for the first liquid chromatography system is predetermined by performing a fit of a mathematical function to a plurality of data points, each of the data points indicating a value of a programmed gradient slope and a delivered gradient slope predetermined to correspond to the value of the programmed gradient slope.
